(19) United States
(12) Patent Application Publication
(10) Pub. No.: US 2024/0386620 A1
(43) Pub. Date: Nov. 21, 2024

(54) MIXED REALITY RENDERING SYSTEM

(71) Applicant: NATIONAL CENTRAL UNIVERSITY, Taoyuan (TW)

(72) Inventors: Chih-Wei Huang, Taoyuan (TW); Hong-Lin Zeng, Taoyuan (TW); Zheng-Ting Huang, Taoyuan (TW); Ching-Cherng Sun, Taoyuan (TW)

(73) Assignee: NATIONAL CENTRAL UNIVERSITY, Taoyuan (TW)

(21) Appl. No.: 18/216,377

(22) Filed: Jun. 29, 2023

(30) Foreign Application Priority Data
May 15, 2023 (TW) 112117992

(51) Int. Cl. G06T 11/00; G06F 1/16; G06F 3/01

(52) U.S. Cl. CPC G06T 11/00; G06F 1/163; G06F 3/012

(57) ABSTRACT

A mixed reality rendering system includes a display device and a server, wherein the display device is at a user end, and the server is at a remote end. A native object is built in the server, wherein the native object has a virtual coordinate. The remote server converts a physical coordinate of the display device into a virtual coordinate. The server generates a virtual straight line based on the virtual coordinate of the display device and the virtual coordinate of the native object. A virtual streaming camera is generated on the virtual straight line based on a predetermined distance. The server renders a rendered object based on the virtual streaming camera.

### BACKGROUND OF THE DISCLOSURE

### 1. Field of the Disclosure

The present invention relates generally to a mixed reality rendering system, and more particularly to one capable of reducing the occurrence of display distortion and jitter on the display plane of a display device.

### 2. Description of the Prior Art

Mixed Reality (MR) is an interactive technology experience that integrates Virtual Reality (VR) and Augmented Reality (AR) techniques. Mixed Reality combines the virtual and real worlds, allowing users to interact with virtual objects in a real environment while perceiving the surrounding physical environment.

Typically, systems utilizing Mixed Reality technology employ Head-Mounted Displays (HMDs) to present virtual content. To reduce the computational load on HMDs for processing virtual content, the current approach involves using a cloud server or an edge server for the computation of virtual content. The position and the head pose (or orientation) information of the HMD is transmitted over the network to the cloud server of the edge server, which then calculates the virtual content based on this information. The calculated virtual content is then outputted as a two-dimensional video stream and sent back to the HMD through the network. The HMD decodes the two-dimensional video stream using a decoder.

However, the aforementioned architecture utilizing remote servers introduces the issue of Mixed Reality Time-to-Photons (MTP) delay. This is caused by factors such as the generation and transmission of virtual content by the remote server and the decoding process in the HMD. As a result, there can be a mismatch between the video seen by the user and the current position or head pose of the HMD, leading to screen jitter and an unsatisfactory user experience.

### SUMMARY OF THE DISCLOSURE

In light of this, the present invention provides a mixed reality rendering system which is capable of reducing the occurrence of display distortion and jitter on the display plane of a display device.

The present invention provides a mixed reality rendering system which includes a display device and a server, wherein the display device is at a user end, and the server is at a remote end. The server has a native object built therein, and the native object has a virtual coordinate. The mixed reality rendering system is adapted to perform the following steps: the display device and the server establish a communication therebetween; the display device detects a physical coordinate of the display device at a first time point, and transmits the physical coordinate of the display device to the server; the server converts the physical coordinate of the display device into a virtual coordinate; the server generates a virtual straight line passing through the virtual coordinate of the display device and the virtual coordinate of the native object based on an equation; the server generates a virtual streaming camera based on the virtual straight line and a predetermined distance, wherein the virtual streaming camera has a virtual camera coordinate, and the virtual streaming camera is located on the virtual straight line; and the server renders a rendered object based on the virtual streaming camera.

In an embodiment, the mixed reality rendering system is adapted to further perform the following steps: the server transmits the rendered object to the display device; and the display device displays the rendered object at a second time point, wherein the second time point is later than the first time point.

In an embodiment, the mixed reality rendering system is adapted to further perform the following steps: the server transmits the virtual coordinate of the native object to the display device; the display device converts the virtual coordinate of the native object into a physical object coordinate; and the display device displays the rendered object at the physical object coordinate at the second time point.

In an embodiment, the mixed reality rendering system is adapted to further perform the following steps: the display device detects a head orientation of the display device at the first time point, and transmits the head orientation to the server; the server creates a visible cone based on the virtual coordinate of the display device and the head orientation; the server determines whether the native object is located within the visible cone; when the native object is located within the visible cone, the server transmits the rendered object to the display device; and the display device displays the rendered object at a second time point, wherein the second time point is later than the first time point.

In an embodiment, the mixed reality rendering system is adapted to further perform the following step: when the native object is not located within the visible cone, the server does not transmit the rendered object to the display device.

In an embodiment, the mixed reality rendering system is adapted to further perform the following steps: the server defines frame boundaries, wherein the frame boundaries contain the native object inside; the server determines whether vertices of the frame boundaries are all outside of the visible cone; and when the vertices of the frame boundaries are all outside of the visible cone, the server does not transmit the rendered object to the display device.

In an embodiment, a distance between the virtual camera coordinate and the virtual coordinate of the native object equals the predetermined distance.

In an embodiment, the server further has another native object built therein, wherein the another native object has another virtual coordinate; the mixed reality rendering system is adapted to further perform the following steps: the server generates another virtual straight line passing through the virtual coordinate of the display device and the another virtual coordinate of the another native object based on another equation; the server generates another virtual streaming camera based on the another virtual straight line and another predetermined distance, wherein the another virtual streaming camera has another virtual camera coordinate, and the another virtual streaming camera is located on the another virtual straight line; and the server renders another rendered object based on the another virtual streaming camera.

In an embodiment, the mixed reality rendering system is adapted to further perform the following steps: the server transmits the rendered object and the another rendered object to the display device; and the display device displays the rendered object and the another rendered object at a second time point, wherein the second time point is later than the first time point.

In an embodiment, the mixed reality rendering system is adapted to further perform the following steps: the server transmits the another virtual coordinate of the another native object to the display device; the display device converts the another virtual coordinate of the anther native object into another physical object coordinate; and the display device displays the another rendered object at the another physical object coordinate at the second time point.

The above-mentioned and other technical details, features, and advantages regarding the present invention will be clearly presented in the detailed description below with related accompanying drawings.

### BRIEF DESCRIPTION OF THE DRAWINGS

The present invention will be best understood by referring to the following detailed description of embodiments in conjunction with the accompanying drawings, in which

FIG. 1 is a schematic view of a mixed reality rendering system of a first embodiment of the present invention at the user end;

FIG. 2 is a schematic view of a mixed reality rendering system of the first embodiment of the present invention at the server end;

FIG. 3 is a schematic view of the mixed reality rendering system of the first embodiment of the present invention, showing the display at the user end at the first time point;

FIG. 4 is a schematic view of the mixed reality rendering system of the first embodiment of the present invention, showing the display at the server end during rendering;

FIG. 5 is a schematic view of the mixed reality rendering system of the first embodiment of the present invention, showing the display at the user end at the second time point;

FIG. 6 is a schematic view of the mixed reality rendering system of a second embodiment of the present invention at the user end at the first time point;

FIG. 7 is a schematic view of the mixed reality rendering system of the second embodiment of the present invention at the server end at the first time point;

FIG. 8 is a schematic view of the mixed reality rendering system of the second embodiment of the present invention at the user end at the second time point;

FIG. 9 is a schematic view of the mixed reality rendering system of the second embodiment of the present invention, showing the display at the user end at the first time point;

FIG. 10 is a schematic view of the mixed reality rendering system of the second embodiment of the present invention, showing the display at the server end during rendering; and

FIG. 11 is a schematic view of the mixed reality rendering system of the second embodiment of the present invention, showing the display at the user end at the second time point.

### DETAILED DESCRIPTION

To facilitate the understanding of those skilled in the art, the present invention will be further described below with embodiments and accompanying drawings. It should be noted that the accompanying drawings are simplified schematic views. Therefore, the drawings only show the components and their relationships relevant to the present invention, aiming to provide a clearer description of the basic structure or implementation of the present invention. The actual components and arrangement may be more complex. Additionally, for the purpose of illustration, the components shown in the drawings of the present invention are not drawn to scale in terms of their numbers, shapes, and sizes as implemented in practice. The detailed proportions can be adjusted according to the design requirements.

The directional terms used in the following embodiments, such as “up,” “down,” “left,” “right,” “front,” or “back,” are solely for reference to the accompanying drawings. Therefore, the directional terms used are for illustrative purposes and not intended to limit the scope of the present invention.

Although the terms “first,” “second,” “third,” and so on may be used to describe various components, these terms are not limiting. They are used merely to distinguish a particular component from other components in the specification. The same terms may not be used in the claims, and instead, the terms “first,” “second,” “third,” and so on may be replaced according to the order in which the components are declared in the claims. Consequently, in the following description, the “first” component may correspond to the “second” component mentioned in the claims.

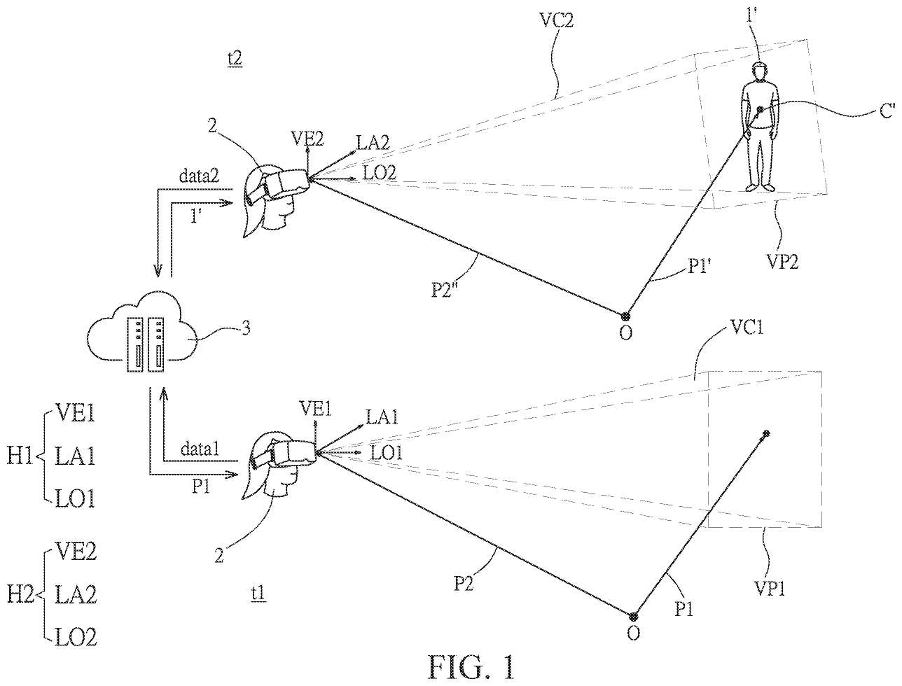

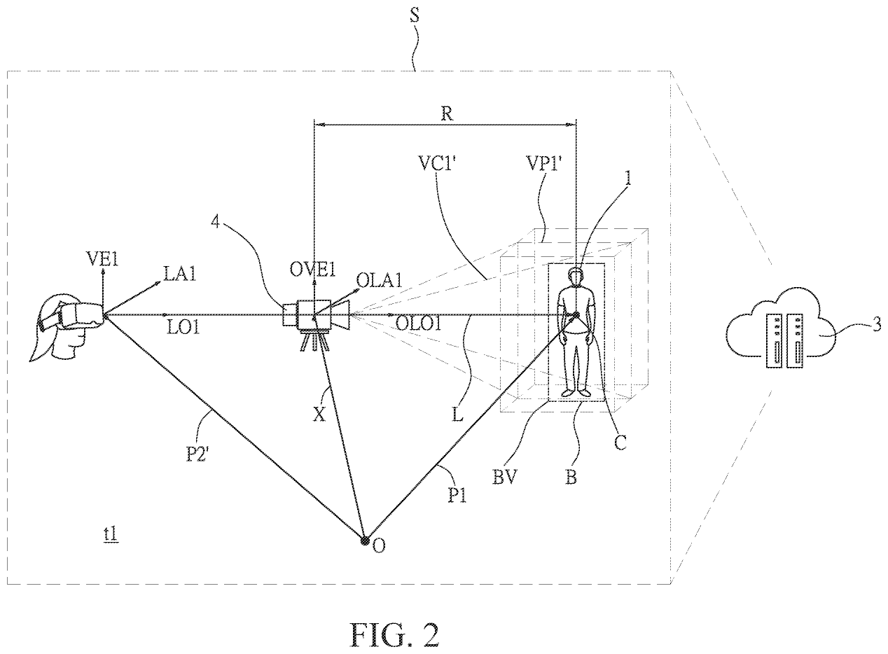

Please refer to FIG. 1 and FIG. 2, wherein FIG. 1 is a schematic view of a mixed reality rendering system of a first embodiment of the present invention at the user end, and FIG. 2 is a schematic view of the mixed reality rendering system of the first embodiment of the present invention at the server end. The mixed reality rendering system includes a display device 2 and a server 3, wherein the display device 2 and the server 3 could establish communication through wireless network, but this is not a limitation of the present invention. Whereby, the display device 2 could transmit data such as the user's head movement and position to the server 3, while the server 3 could render and process virtual contents based on these data, and transmit the processed virtual contents back to the display device 2 to allow the user to view and interact with.

In practice, the display device 2 could be a head mounted display, (HMD), which could include a screen, a sensor, an audio device, and a controller. The screen is located at a front of the HMD to display virtual contents. The sensor includes a gyroscope, an accelerometer, a magnetometer, etc., and is used to track the user's head movement and position, allowing virtual content to be rendered based on the user's perspective and position. The audio device could include headphones or built-in speakers, used to provide sound effects and enhance the mixed reality experience. The controller is used to interact with virtual content, and could be a hand controller, a gesture recognition device, and so on.

The server 3 could be a cloud server or an edge server, and could include a computing server unit, a data storage unit, a network connectivity unit, and a virtual content development tool. The computing server unit is used for generating and rendering virtual contents. The data storage unit is used to store virtual contents and user data, such as virtual models, textures, audio, etc. The network connectivity unit provides communication between the display device 2 and the server 3, typically using high-speed wireless network technologies such as Wi-Fi or 5G network, to achieve fast and stable data transmission. The virtual content development tool include software, engines, and development tools for creating and editing virtual contents, specifically tailored for head-mounted displays.

Additionally, the present invention utilizes Unity3D as the platform for developing applications for the display device 2 and the server 3. However, it is not a limitation, as existing application development plugins could be also used for the display device 2 and the server 3. One example is the Microsoft Mixed Reality Toolkit (MRTK), developed by Microsoft. MRTK provides functionalities such as hand recognition, spatial awareness, and virtual interaction components like buttons and virtual keyboards. However, the present invention does not exclude the possibility of using other mixed reality software tools.

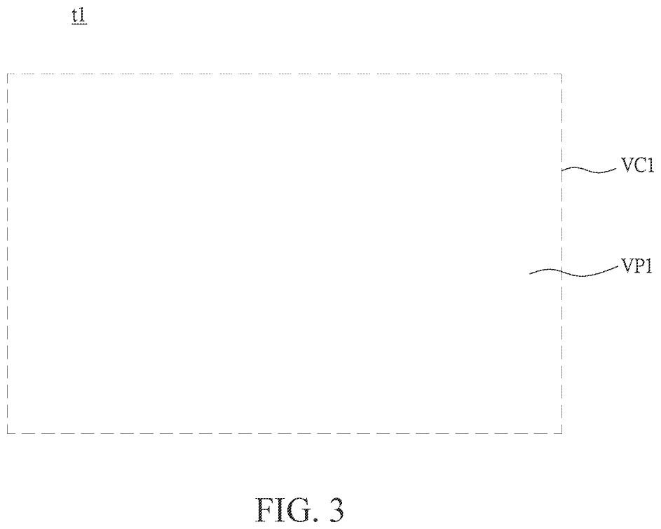

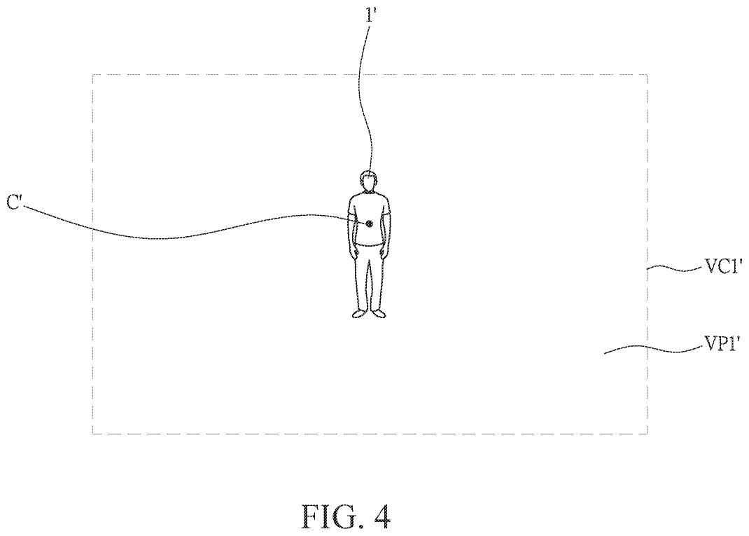

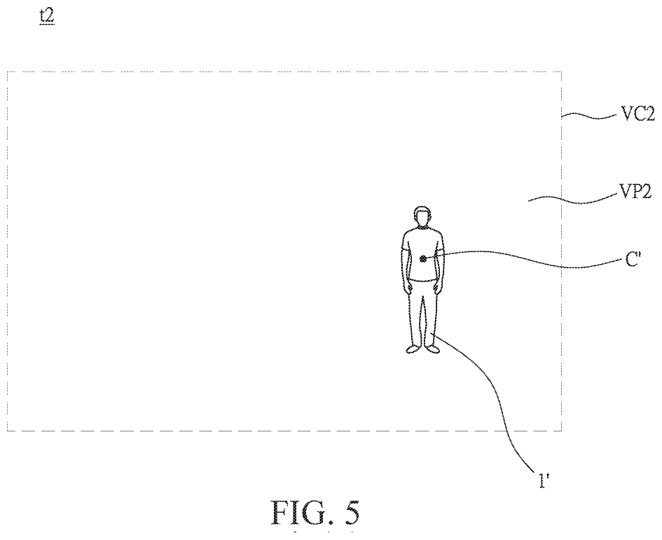

Please refer to FIG. 3 to FIG. 5 altogether, wherein FIG. 3 is a schematic view showing a display of the mixed reality rendering system of the first embodiment of the present invention seen at the user end at a first time point t1; FIG. 4 is also a schematic view, showing a display of the mixed reality rendering system of the first embodiment of the present invention seen at the server end during rendering after the first time point t1; FIG. 5 is a schematic view as well, representing a display of the mixed reality rendering system of the first embodiment of the present invention seen at the user end at a second time point t2. The server 3 has a native object 1 built therein, wherein the native object 1 has a virtual coordinate P1. It is worth mentioning that, in the illustrations relating to the current embodiment, the virtual coordinate P1 of the native object 1 is represented by pointing to a native displaying center C of the native object 1 from a coordinate origin O of a virtual rendering space S constructed by the server 3 in a manner of a vector, and the virtual coordinate P1 of the native object 1 could be represented by a coordinate, which means that the virtual coordinate P1 of the native object 1 could be represented by equation (1):

$$\vec{P 1} = ( P 1 x , P 1 y , P 1 z ) \qquad ( 1 )$$

wherein \vec{P1} represents a position vector of the virtual coordinate P1 of the native object 1; P1x is an x-axis coordinate (or x-component) of the position vector; P1y is a y-axis coordinate (or y-component) of the position vector; P1z is a z-axis coordinate (or z-component) of the position vector.

To facilitate understanding of the operation of the current embodiment, herein we first explain the general steps performed by the mixed reality computing system:

Step S100: the display device 2 the server 3 establish communication therebetween;

Step S101: the server 3 transmits the virtual coordinate P1 of the native object 1 to the display device 2;

Step S102: the display device 2 converts the virtual coordinate P1 of the native object 1 into a physical object coordinate P1′;

Step S103: the display device 2 detects a physical coordinate P2 of the display device 2 at a first time point t1, and transmits the physical coordinate P2 of the display device 2 to the server 3;

Step S104: the server 3 converts the physical coordinate P2 of the display device 2 into a virtual coordinate P2′ of the display device 2;

Step S105: the server 3 generates a virtual straight line L passing through the virtual coordinate P2′ of the display device 2 and the virtual coordinate P1 of the native object 1 based on an equation;

Step S106: the server 3 generates a virtual streaming camera 4 based on the virtual straight line L and a predetermined distance R, wherein the virtual streaming camera 4 has a virtual camera coordinate, and the virtual streaming camera 4 is located on the virtual straight line L;

Step S107: the server 3 renders a rendered object 1′ based on the virtual streaming camera 4;

Step S108: the server 3 transmits the rendered object 1′ to the display device 2; and

Step S109: the display device 2 displays the rendered object 1′ at the physical object coordinate P1′ at a second time point t2, wherein the second time point t2 is later than the first time point t1.

Please refer to FIG. 1 to FIG. 5 again. The following description is provided in conjunction with the aforementioned steps. It is important to understand that in the description of the current embodiment, the operation of the mixed reality computing system between the first time point t1 and the second time point t2 is used to illustrate the concept of the present invention. The second time point t2 occurs after the first time point t1, but it should be noted that the mixed reality computing system is not limited to operating only between two closely adjacent time points. Instead, it provides a continuous and seamless operational experience. In other words, the following text, which focuses on the first time point t1 and the second time point t2, is solely for the purpose of convenience in explanation and understanding, and does not imply or impose any limitations on the usage scenarios.

First, the display device 2 and the server 3 could establish communication therebetween through high-speed wireless network technologies such as Wi-Fi or 5G network (i.e., Step S100) so that the server 3 could transmit the virtual coordinate P1 of the built-in native object 1 to the display device 2 at the first time point t1 (or even earlier) (i.e., Step S101). After the display device 2 receives the virtual coordinate P1 of the native object 1 transmitted from the server 3, the display device 2 could convert the virtual coordinate P1 of the native object 1 from a coordinate into the physical object coordinate P1′ (i.e., Step S102), which is preserved for use at the second time point t2. In the current embodiment, the virtual coordinate P1 of the native object 1 built in the server 3 equals the physical object coordinate P1′ converted from a coordinate by the display device 2; however, this is not a limitation of the present invention.

At the first time point t1, the display device 2 would also use the sensor (e.g., a gyroscope, an accelerometer, a magnetometer, etc.,) to detect a physical coordinate P2 of the display device 2 and a first head orientation H1, wherein the first head orientation H1 in the current embodiment is expressed using vectors in three spatial directions. Specifically, it is composed of a first vertical axis VE1, a first lateral axis LA1, and a first longitudinal axis LO1. The physical coordinate P2 of the display device 2 and the first head orientation H1 would be encapsulated together as a first data datal and then transmitted to the server 3 (i.e., Step S103). After the server 3 receives the first data data1 transmitted from the display device 2, the server 3 would extract the physical coordinate P2 of the display device 2 contained therein, and converts it into a virtual coordinate P2′ (i.e., Step S104). The server 3 could deduce a first visible cone VC1 based on the physical coordinate P2 of the display device 2 and the first head orientation H1, and the first visible cone VC1 is the field of view visible to the user after putting on the display device 2. Furthermore, the first visible cone VC1 could form a first virtual plane VP1. It should be noted that at the first time point t1, there are no images of virtual objects generated on the first virtual plane VP1.

In conclusion, Step S100, Step S101, Step S102, Step S103, and Step S104 are a initialization process for the display device 2 and the server 3, so that the physical object coordinate P1′ converted by the display device 2 and the virtual coordinate P1 of the native object 1 built in the server 3 could sync with each other. Furthermore, the physical coordinate P2 of the display device 2 detected by the display device 2 and the virtual coordinate P2′ of the display device 2 converted by the server 3 could sync with each other as well. However, the parameters synchronized during the initialization process of the display device 2 and the server 3 in the present invention are not limited as described in the current embodiment. For example, development plugins in existing applications can provide users with the ability to zoom in or out on the native object 1 using the display device 2. In such cases, the display device 2 could transmit the scaling factor for zooming in or out of the native object 1 to the server 3.

As previously mentioned, the physical object coordinate P1′, the physical coordinate P2 of the display device 2, and the virtual coordinate P2′ of the display device 2 illustrated in the drawings of the current embodiment are all expressed as vectors. However, this is not a limitation of the present invention. For example, the physical object coordinate P1′, the physical coordinate P2 of the display device, and the virtual coordinate P2′ of the display device 2 could also be represented by coordinates, which also refers to the coordinate origin O of the virtual rendering space S constructed by the server 3. In other words, the physical object coordinate P1′, the physical coordinate P2 of the display device 2, and the virtual coordinate P2′ of the display device 2 could be respectively represented by equation (2), equation (3), and equation (4):

$${\vec{P 1}}^{′} = ( P {1}^{′} x , P {1}^{′} y , P {1}^{′} z ) \qquad ( 2 )$$

wherein P1′ represents a position vector of the physical object coordinate P1′; P1′x is an x-axis coordinate (or x-component) of the position vector; P1′y is a y-axis coordinate (or y-component) of the position vector; P1′z is a z-axis coordinate (or z-component) of the position vector.

$$\vec{P 2} = ( P 2 x , P 2 y , P 2 z ) \qquad ( 3 )$$

wherein \vec{P2} represents a position vector of the physical coordinate P2 of the display device 2; P2x is an x-axis coordinate (or x-component) of the position vector; P2yis a y-axis coordinate (or y-component) of the position vector; P2z is a z-axis coordinate (or z-component) of the position vector.

$${\vec{P 2}}^{′} = ( P {2}^{′} x , P {2}^{′} y , P {2}^{′} z ) \qquad ( 4 )$$

wherein \vec{P2}′ represents a position vector of the virtual coordinate P2′ of the display device 2; P2′x is an x-axis coordinate (or x-component) of the position vector; P2′yis a y-axis coordinate (or y-component) of the position vector; P2′z is a z-axis coordinate (or z-component) of the position vector.

Furthermore, the server 3 generates the virtual straight line L passing through the virtual coordinate P2′ of the display device 2 and the virtual coordinate P1 of the native object 1 based on an equation (i.e., Step S105), wherein the equation for generating the virtual straight line L is equation (5) shown below:

$$\vec{L} = {\vec{P 2}}^{′} - \vec{P 1} \qquad ( 5 )$$

wherein \vec{L} is a position vector of the virtual straight line L; \vec{P2}′ is the position vector of the virtual coordinate P2′ of the display device; \vec{P1} is the position vector of the virtual coordinate P1 of the native object 1.

In addition, as shown in FIG. 2, the server 3 generates the virtual streaming camera 4 based on the virtual straight line L and the predetermined distance R, wherein the virtual streaming camera 4 has a virtual camera coordinate X, which also refers to the coordinate origin O of the virtual rendering space S constructed by the server 3, and the virtual streaming camera 4 is located on the virtual straight line L (i.e., Step S106).

Similarly, the virtual camera coordinate X illustrated in the drawings of the current embodiment is represented in a manner of a vector; however, this is not a limitation of the present invention. For example, the virtual camera coordinate X could also be represented by a coordinate. In other words, the virtual camera coordinate X could be represented by equation (6):

$$\vec{X} = ( Xx , Xy , Xz ) \qquad ( 6 )$$

wherein \vec{X} represents a position vector of the virtual camera coordinate X; Xx is an x-axis coordinate (or x-component) of the position vector; Xy is a y-axis coordinate (or y-component) of the position vector; Xz is a z-axis coordinate (or z-component) of the position vector.

In other words, the virtual camera coordinate X of the virtual streaming camera 4 is made located on the virtual straight line L, and is apart from the virtual coordinate P1 of the native object 1 by the predetermined distance R, wherein the predetermined distance R could be a system default value, or could be determined based on the size of the native object 1 and a virtual first visible cone VC1′ of the virtual streaming camera 4. The actual value depends on the specific situation. The virtual first visible cone VC1′ is determined based on the virtual camera coordinate X of the virtual streaming camera 4 and its vectors in three spatial directions, wherein the spatial vectors include a first object vertical axis OVE1, a first object lateral axis OLA1, and a first object longitudinal axis OLO1. The virtual first visible cone VC1′ could form a virtual first virtual plane VP1′, and on the virtual first virtual plane VP1′, the native displaying center C of the native object 1 is located at the virtual coordinate P1 of the native object 1.

As shown in FIG. 3, there are no virtual objects visible on the first virtual plane VP1 of the display device 2 at the first time point t1, as the server 3 has not yet provided any virtual objects at this time.

Then, the server 3 proceeds with the operation seen in FIG. 4 after receiving the first data datal transmitted from the display device 2. The server 3 renders a rendered object l′ based on the virtual streaming camera 4 (i.e., Step S107), and presents the rendered object 1′ on the virtual first virtual plane VP1′, wherein the rendered object 1′ has a rendered displaying center C′. After that, the server 3 transmits the rendered object 1′ to the display device 2 (i.e., Step S108). At this point, the display device 2 is ready to present the received rendered object 1′on the virtual screen.

Please refer to FIG. 1 and FIG. 5 at the same time. At the second time point t2, the user's head moves, and the display device 2 uses the sensor again to detect a new physical coordinate P2″ of the display device 2 and a new second head orientation H2. As previously mentioned, the second head orientation H2 in the current embodiment is also expressed using vectors in three spatial directions. Specifically, it is composed of a second vertical axis VE2, a second lateral axis LA2, and a second longitudinal axis LO2. The server 3 could deduce a second visible cone VC2 based on the physical coordinate P2″ of the display device 2 and the second head orientation H2, and the second visible cone VC2 is the field of view which could be presented by the display device 2 at the second time point t2. The second visible cone VC2 could form a second virtual plane VP2. On the second virtual plane VP2, the display device 2 presents the rendered object 1′ at the physical object coordinate P1′, wherein a rendered displaying center C′ of the rendered object 1′ is located at the physical object coordinate P1′ (i.e., Step S109). At this point, the imaging of the mixed reality rendering system is completed. In fact, after Step S109, the display device 2 would further encapsulate the physical coordinate P2″ of the display device 2 and the second head orientation H2 together into a second data data2, and then transmit to the server 3 to become the basis for rendering a new rendered object at a next time point.

It is worth mentioning that the server 3 also defines frame boundaries B to contain the native object 1 therein. In Step S107, the server 3 would first check if the native object 1 is located within the first visible cone VC1. If yes, it means that the virtual object should be presented on the display of the display device 2, and therefore the server 3 would render the rendered object 1′, and transmit the rendered object 1′ to the display device 2 in the subsequent steps; otherwise, the virtual object would not be visible for the display device 2, and therefore it would not be necessary for the server 3 to transmit the rendered object 1′ to the display device 2. More specifically, the server 3 could check four vertices BV of the frame boundaries B to see if all of the vertices BV are located out of the first visible cone VC1. If so, then the server 3 would not transmit the rendered object 1′ to the display device 2.

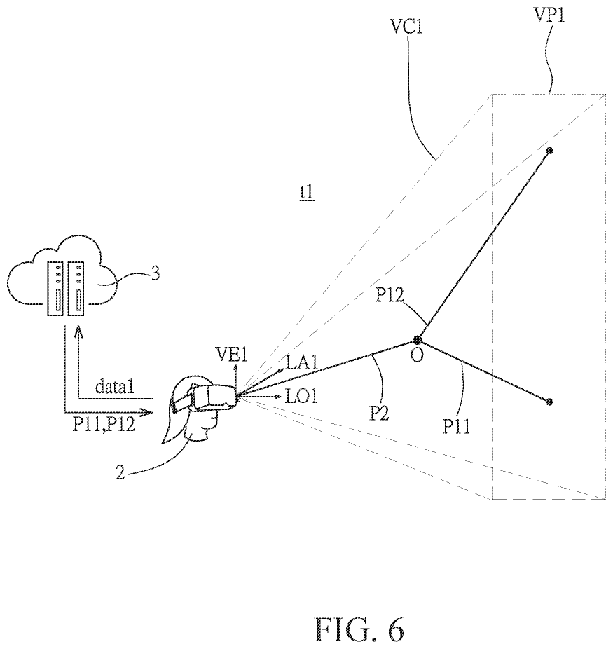

A second embodiment of the present invention is shown in FIG. 6 to FIG. 11, illustrating a scenario where the mixed reality rendering system involves two native objects. All virtual coordinates mentioned in the current embodiment could be represented by coordinates as well, and also refer to the coordinate origin O of the virtual rendering space S constructed by the server 3. We will not elaborate further on the representation of each virtual coordinate in the following text, for it follows the same concept described above.

Please refer to FIG. 6 first, similar to the previous embodiment, the display device 2 would encapsulate the physical coordinate P2 of the display device 2 and the first head orientation H1 together as a first data datal at the first time point t1, and transmit the first data datal to the server 3. Then the server 3 transmits a virtual coordinate P11 of a native object 10 and a virtual coordinate P12 of another native object 20 to the display device 2. The display device 2 respectively converts their coordinates into two physical object coordinates P11′ and P12′, which respectively correspond to one of the native objects 10, 20. However, at this point, no virtual objects have been generated on the first virtual plane VP1 yet.

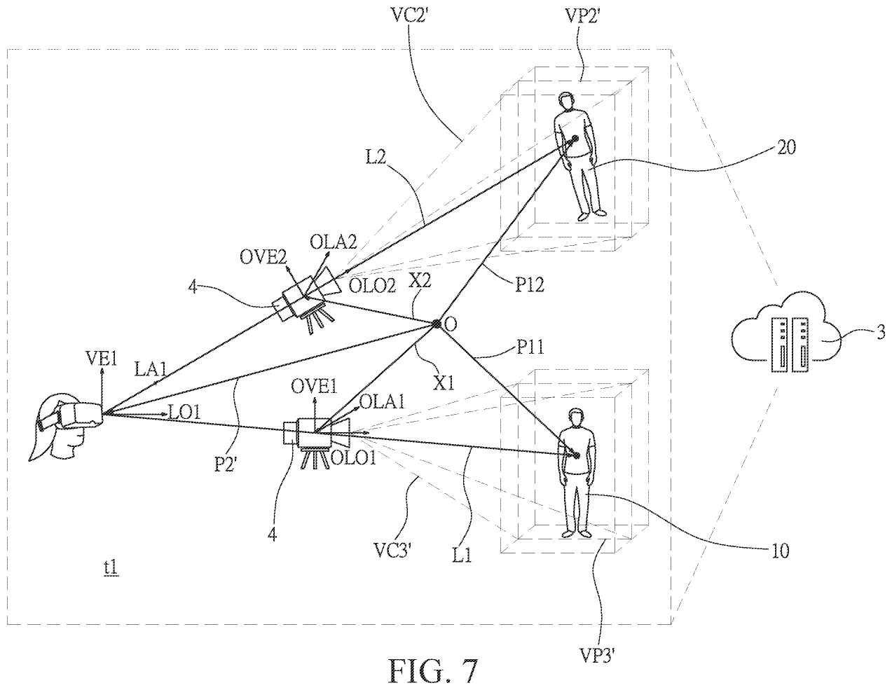

As shown in FIG. 7, after the server 3 receives the first data datal transmitted from the display device 2, the server 3 would then retract the physical coordinate P2 of the display device 2 contained therein, and convert it into a virtual coordinate P2′. Since the current embodiment has two native objects 10, 20, the server 3 would need to correspondingly generate two virtual straight lines L, wherein one of the virtual straight lines L is generated based on equation (6) shown below, passing through the virtual coordinate P2′ of the display device 2 and the virtual coordinate P11 of the native object 10, while the other one of the virtual straight lines L is generated based on equation (7) shown below, passing through the virtual coordinate P2′ of the display device 2 and the virtual coordinate P12 of the another native object 20.

$$\vec{L} = {\vec{P 2}}^{′} - \vec{P 11} \qquad ( 6 )$$

$$\vec{L} = {\vec{P 2}}^{′} - \vec{P 12} \qquad ( 7 )$$

After that, the server 3 generates a virtual streaming camera 4 on each of the two virtual straight lines L respectively, wherein one of the virtual streaming cameras 4 has a virtual camera coordinate X1, which also refers to the coordinate origin O of the virtual rendering space S constructed by the server 3, and the other one of the virtual streaming cameras 4 has a virtual camera coordinates X2. A virtual second visible cone VC2′ is determined by the virtual camera coordinate X2 of one of the virtual streaming cameras 4 and its vectors in three spatial directions, wherein the spatial vectors include a second object vertical axis OVE2, a second object lateral axis OLA2, and a second object longitudinal axis OLO2. The virtual second visible cone VC2′ could form a virtual second virtual plane VP2′, and on the virtual second virtual plane VP2′, a native displaying center (not shown) of the another native object 20 is located at the virtual coordinate P12 of the another native object 20. In addition, a virtual third visible cone VC3′ is determined by the virtual camera coordinate X1 of the other one of the virtual streaming cameras 4 and its vectors in three spatial directions, wherein the spatial vectors include a first object vertical axis OVE1, a first object lateral axis OLA1, and a first object longitudinal axis OLO1. The virtual third visible cone VC3′ could form a virtual third virtual plane VP3′, and on the virtual third virtual plane VP3′, a native displaying center (not shown) of the native object 10 is located at the virtual coordinate P11 of the native object 10.

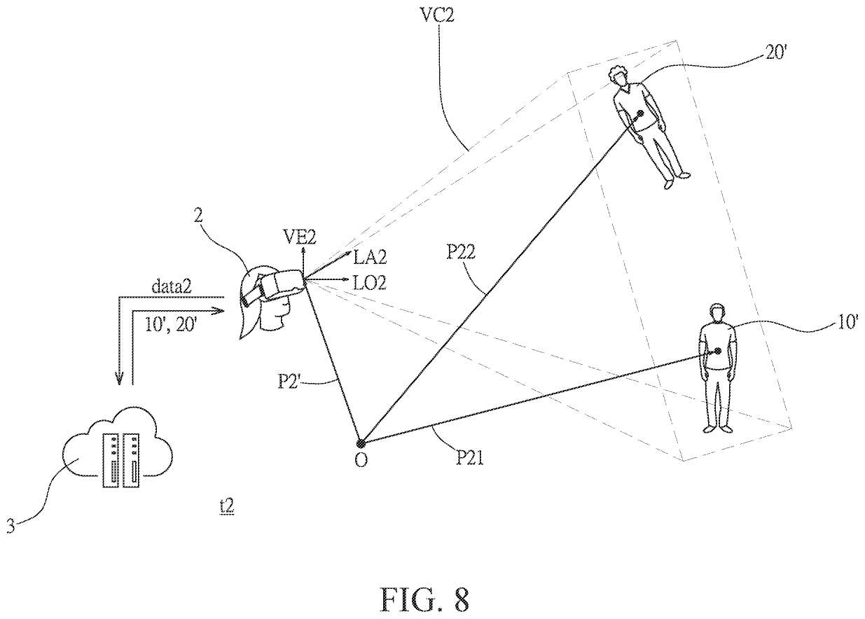

And then, as shown in FIG. 8, the server 3 renders a rendered object 10′ and another rendered object 20′ respectively based on the two virtual streaming cameras 4, and transmits the rendered object 10′ and the another rendered object 20′ to the display device 2. At this point, the display device 2 is ready to present the received rendered object 10′ and another rendered object 20′ on the virtual screen.

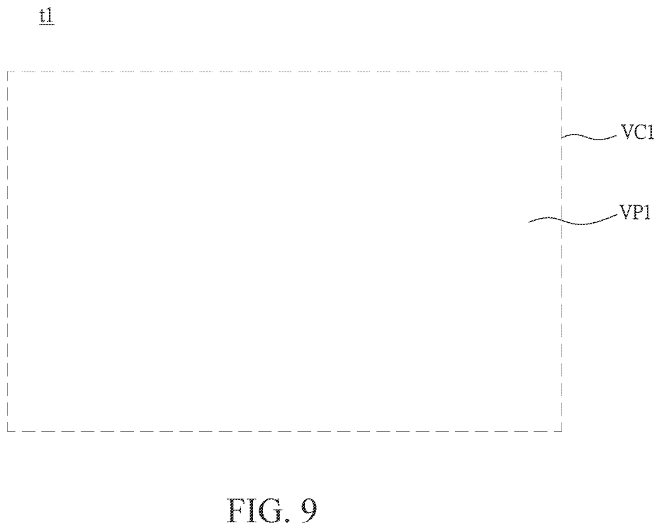

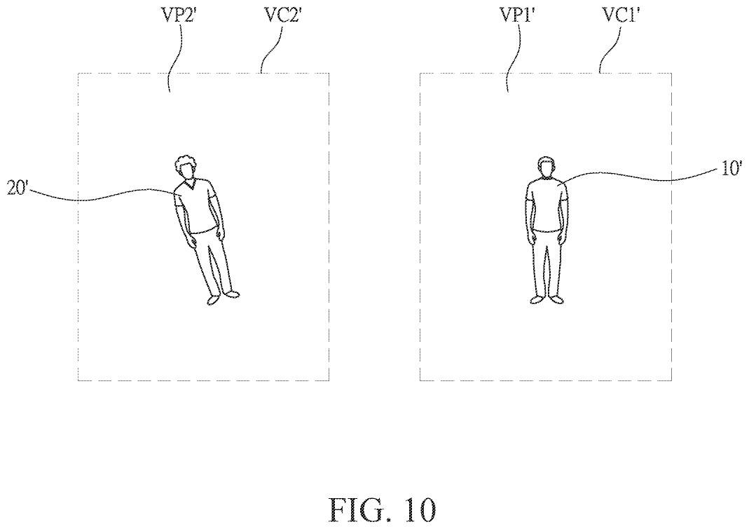

By the way, the time point shown in FIG. 9 is the first time point t1. At this point, the server 3 has not provided any virtual objects yet, and therefore no virtual objects are visible on the first virtual plane VP1 of the display device 2. After that, as shown in FIG. 10, the server 3 respectively presents the rendered object 10′ and the another rendered object 20′ on the virtual first virtual plane VP1′ and the virtual second virtual plane VP2′.

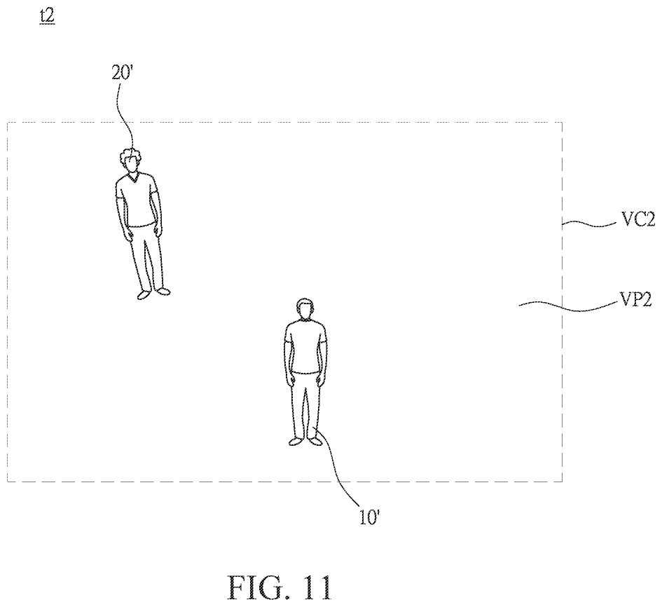

Lastly, please refer to FIG. 11, at the second time point t2, the field of view which could be presented by the display device 2 at the second time point t2 is a second visible cone VC2, and the second visible cone VC2 could form a second virtual plane VP2. The display device 2 could respectively show the rendered object 10′ and the another rendered object 20′ on the second virtual plane VP2. At this point, the imaging of the mixed reality rendering system is completed.

With the mixed reality computing system provided by the present invention, at the second time point t2, the user would still see the rendered objects on the display plane based on the previous time point (i.e., the first time point t1) and the physical coordinate P2 of the display device 2. This reduces the occurrence of offset and jitters on the display plane of the display device 2, minimizing the discontinuity or abruptness experienced by the user when viewing the mixed reality.

It should be realized that the above description is only one embodiment of the present invention and should not be deemed as limitations of implementing the present invention. All substantially equivalent variations and modifications which employ the concepts disclosed in this specification and the appended claims should fall within the scope of the present invention.

What is claimed is:

1. A mixed reality rendering system, comprising:
a display device at a user end; and
a server at a remote end, wherein the server has a native object built therein, and the native object has a virtual coordinate;
wherein the mixed reality rendering system is adapted to perform the following steps:
the display device and the server establish a communication therebetween;
the display device detects a physical coordinate of the display device at a first time point, and transmits the physical coordinate of the display device to the server;
the server converts the physical coordinate of the display device into a virtual coordinate;
the server generates a virtual straight line passing through the virtual coordinate of the display device and the virtual coordinate of the native object based on an equation;
the server generates a virtual streaming camera based on the virtual straight line and a predetermined distance, wherein the virtual streaming camera has a virtual camera coordinate, and the virtual streaming camera is located on the virtual straight line; and
the server renders a rendered object based on the virtual streaming camera.

2. The mixed reality rendering system of claim 1, wherein the mixed reality rendering system is adapted to further perform the following steps:
the server transmits the rendered object to the display device; and
the display device displays the rendered object at a second time point, wherein the second time point is later than the first time point.

3. The mixed reality rendering system of claim 2, wherein the mixed reality rendering system is adapted to further perform the following steps:
the server transmits the virtual coordinate of the native object to the display device;
the display device converts the virtual coordinate of the native object into a physical object coordinate; and
the display device displays the rendered object at the physical object coordinate at the second time point.

4. The mixed reality rendering system of claim 1, wherein the mixed reality rendering system is adapted to further perform the following steps:
the display device detects a head orientation of the display device at the first time point, and transmits the head orientation to the server;
the server creates a visible cone based on the virtual coordinate of the display device and the head orientation;
the server determines whether the native object is located within the visible cone;
when the native object is located within the visible cone, the server transmits the rendered object to the display device; and
the display device displays the rendered object at a second time point, wherein the second time point is later than the first time point.

5. The mixed reality rendering system of claim 4, wherein the mixed reality rendering system is adapted to further perform the following step:
when the native object is not located within the visible cone, the server does not transmit the rendered object to the display device.

6. The mixed reality rendering system of claim 1, wherein the mixed reality rendering system is adapted to further perform the following steps:
the server defines frame boundaries, wherein the frame boundaries contain the native object inside;
the server determines whether vertices of the frame boundaries are all outside of the visible cone; and
when the vertices of the frame boundaries are all outside of the visible cone, the server does not transmit the rendered object to the display device.

7. The mixed reality rendering system of claim 1, wherein a distance between the virtual camera coordinate and the virtual coordinate of the native object equals the predetermined distance.

8. The mixed reality rendering system of claim 1, wherein the server further has another native object built therein, wherein the another native object has another virtual coordinate; the mixed reality rendering system is adapted to further perform the following steps:
the server generates another virtual straight line passing through the virtual coordinate of the display device and the another virtual coordinate of the another native object based on another equation;
the server generates another virtual streaming camera based on the another virtual straight line and another predetermined distance, wherein the another virtual streaming camera has another virtual camera coordinate, and the another virtual streaming camera is located on the another virtual straight line; and
the server renders another rendered object based on the another virtual streaming camera.

9. The mixed reality rendering system of claim 8, wherein the mixed reality rendering system is adapted to further perform the following steps:
the server transmits the rendered object and the another rendered object to the display device; and
the display device displays the rendered object and the another rendered object at a second time point, wherein the second time point is later than the first time point.

10. The mixed reality rendering system of claim 9, wherein the mixed reality rendering system is adapted to further perform the following steps:
the server transmits the another virtual coordinate of the another native object to the display device;
the display device converts the another virtual coordinate of the anther native object into another physical object coordinate; and
the display device displays the another rendered object at the another physical object coordinate at the second time point.
